(19) United States
(12) Patent Application Publication
(10) Pub. No.: US 2025/0173538 A1
(43) Pub. Date: May 29, 2025

(54) METHOD OF USING MACHINE-READABLE CODE TO PROVIDE CHEMICAL SAFETY INFORMATION

(71) Applicant: FirstPower Group LLC, Twinsburg, OH (US)

(72) Inventor: John W. Harley, Peninsula, OH (US)

(73) Assignee: FirstPower Group LLC, Twinsburg, OH (US)

(21) Appl. No.: 18/523,107

(22) Filed: Nov. 29, 2023

(51) Int. Cl. G06K 19/06; G06F 16/955

(52) U.S. Cl. CPC G06K 19/06009; G06F 16/9554

(57) ABSTRACT

A method for a user to obtain current safety information on a chemical with a Safety Data Sheet, the chemical being housed in a container with an aperture used for urging the chemical to be dispensed from the container. The method includes providing a machine-code reading mobile device, the machine-code reading mobile device capable of interfacing with the worldwide web having a display and a machine-code recognition element; providing on the container a machine-readable code; providing a website on the worldwide web comprising the current Safety Data Sheet of the chemical housed within the container; and directing the machine-code reading mobile device at the machine-readable code on the container, the machine-readable code urging the machine-code reading mobile device to interface with the website on the worldwide web having the current Safety Data Sheet on the website to be displayed on the display of the machine-code reading mobile device.

### CROSS-REFERENCE TO RELATED APPLICATIONS

Not applicable.

### STATEMENT REGARDING FEDERALLY SPONSORED RESEARCH AND DEVELOPMENT

Not applicable.

### THE NAMES OF THE PARTIES TO A JOINT RESEARCH AGREEMENT

Not applicable.

### STATEMENT REGARDING PRIOR DISCLOSURES BY THE INVENTOR OR A JOINT INVENTOR

Not applicable.

### BACKGROUND OF THE INVENTION

This invention pertains to the field of using machine-readable code (i.e., picket-fence barcodes, Quick Response (QR) codes) to obtain safety information on chemicals. Specifically, without limitation, the present invention relates to the use of these codes to provide users with current safety information of chemicals, having a Safety Data Sheet, housed in containers.

In one disclosure in U.S. patent application Ser. No. 16/550,646, a method for managing regulatory information associated with information relating to environmental, health, and safety data commonly found in Material Safety Data Sheets by scanning a QR code on a label was disclosed. However, this method focused on managing the data, as opposed to providing a user with current data following exposure to a chemical.

In yet another disclosure in European Patent No. 2,731,344, a process for the sending of a video to a personal video recorder via the scanning of a machine-readable, two-dimensional data matrix with a smart device was disclosed. It described the process of sending videos to a personal video recorder rather than to the scanning device (e.g., a smart device). As referenced in this disclosure, a two-dimensional data matrix could transmit stored data despite greater than fifty percent damage to the surface area of the data matrix. However, this method did not provide a user with current safety data for chemicals or for first-aid information following chemical exposure.

### BRIEF SUMMARY OF THE INVENTION

Provided in this disclosure is the use of machine-readable code on a container that can interface with a machine-code reading mobile device to display current safety information. The machine-code reading mobile device has a machine-code recognition element, such as a camera, a scanner, or any other machine-code recognition element used by a skilled artisan, and a display, such as a screen.

The display provides users with current safety information and use information on chemicals housed within the container. Examples of machine-code reading mobile devices include, without limitation, smart phones, smart devices, or any other device used by the skilled artisan capable of reading machine-readable code and wirelessly interfacing with the worldwide web.

This machine-readable code could include, without limitation, a one-dimensional data matrix (e.g., picket-fenced barcode) or a two-dimensional data matrix (e.g., QR code). A two-dimensional data matrix is useful when a user is working with chemicals that might impair the integrity of a machine-readable code because a two-dimensional data matrix can still transmit stored data despite physical damage over fifty percent of the surface area comprising the data matrix.

Machine-readable code is a useful tool for providing mandated information and updates thereof for users utilizing chemicals. A chemical, which is a substance or group of substances, generally has corresponding safety and use information. For example, certain entities that interface with chemicals operate under public reporting requirements for sharing important information on hazardous chemicals. This information is shared via a Safety Data Sheet (formerly Material Safety Data Sheets).

Importantly, beyond the initial version of the Safety Data Sheet, entities must subsequently update safety information after discovering significant new information concerning a chemical with a Safety Data Sheet. This regulatory requirement means that the safety data for chemicals requiring Safety Data Sheets is in a perpetual state of change.

Thus, entities design and update Safety Data Sheets to provide users with the most current information on hazardous chemicals. From the user standpoint, without a method to readily obtain this required information-or use information that indicate best practices-that affords greater safety awareness, a user's safety might be jeopardized, as a user might be operating under incomplete or obsolete data.

In terms of its constitution, a Safety Data Sheet includes user safety information, such as: identification, hazard identification, composition/information on ingredients, first-aid measures, fire-fighting measures, accidental release measures, handling and storage, exposure controls/personal protection, physical and chemical properties, stability and reactivity, and toxicological information.

Regarding identification of a chemical listed in its Safety Data Sheet, this section identifies the chemical and its recommended uses. Furthermore, it also provides contact information of the supplier, such as its name, address, phone number, importer, and an emergency phone number.

Regarding hazard identification of a chemical listed in its Safety Data Sheet, this section highlights the hazards of the chemical and any relevant warning information. Accordingly, the hazard classification of the chemical is included, along with precautionary statements and pictograms (e.g., skull and crossbones, flame).

Concerning the composition and information on ingredients contained in a chemical with a corresponding Safety Data Sheet, this section shares the ingredients contained, including any impurities and stabilizing additives. Here, the section displays the chemical name, along with common names and synonyms. Furthermore, if the product is a mixture, the concentration of each chemical ingredient can be specified.

Regarding first-aid measures for a chemical having a Safety Data Sheet, this section delineates the initial care that untrained first responders should provide to a user exposed to the chemical. The initial care includes specific instructions for first aid characterized by possible routes of exposure (e.g., inhalation, skin and eye contact, and ingestion), a description of common symptoms or side effects, and general recommendations for acute medical care and special treatment, if necessary.

Viewing fire-fighting measures provided in a Safety Data Sheet for a chemical, this section sets forth recommendations for fighting a fire created by the chemical. Recommendations include suitable and unsuitable extinguishing equipment, advice on specific hazards that can develop from the chemical during the fire, and any special protective equipment for firefighting.

Regarding accidental release measures for a chemical listed in its Safety Data Sheet, this portion gives appropriate responses to leaks, releases, or spills, such as containment and cleanup to minimize exposure to users, property, or the environment. In addition, this portion characterizes responses between large and small spills, particularly where the spilled volume serves as a distinguishing feature.

Regarding handling and storage for a chemical contained in its Safety Data Sheet, this group of information highlights guidance on handling and safe storage of the chemicals. This guidance includes incompatibilities and special storage requirements.

Looking to exposure controls and personal protection from a chemical in its Safety Data Sheet, this information indicates engineering controls, exposure limits, and personal protective measures to minimize user exposure. Specifically, this information includes Permissible Exposure Limits (PELs), Threshold Limit Values (TLVs), and recommended exposure limits.

Regarding physical and chemical properties of a chemical with its Safety Data Sheet, this section shares, if available, the appearance, odor, odor threshold, pH, freezing point, melting point, flash point, solubility, vapor density, vapor pressure, auto-ignition temperature, decomposition temperature, upper and lower flammability, explosive limits, and viscosity of the corresponding chemical. Beyond this, certain chemicals may have additional properties that are relevant to users, such as dust deflagration index for combustible dust, which indicates the explosive potential of a dust.

Regarding the stability and reactivity information contained in a Safety Data Sheet for a chemical, this section showcases the reactivity of the chemical, which describes scientifically tested data. Furthermore, the stability indicates whether the chemical is stable under ambient temperature. If a chemical is not stable, any added stabilizers are described. Also, this section lists known classes of incompatible substances.

Regarding toxicological information for a chemical having a Safety Data Sheet, this section lists likely routes of exposure, such as inhalation or ingestion; the immediate, delayed, and chronic effects of exposure; and a description of symptoms associated with user exposure to the chemical, listed by severity.

According to one aspect of the invention, a method for using a machine-readable code and a machine-code reading mobile device capable of wirelessly connecting to and interfacing with the worldwide web, wherein the device can display current safety information for users interfacing with chemicals requiring a Safety Data Sheet. This method will offer greater safety to a user. Thus, when a user works with or around chemicals, particularly in products that create chemical reactions on electric power equipment, then a method linking these components affords users both current and accessible safety information.

According to another aspect of the invention, chemicals housed in containers can include chemicals used to service electric power equipment. These chemicals can be non-flammable and have a dielectric strength of thirty-five or more kilovolts (kV). Due to the hazardous nature of working with electric power equipment, which in many instances is electrically energized or loaded while users service or repair the equipment, a method is necessary that provides users easy access to the most current safety information, especially of a chemical being used on electric power equipment. Even a portion of the current Safety Data Sheet can provide increased safety by highlighting first-aid measures when users have inhaled, ingested, or been directly exposed to the chemical by eye or skin contact. In addition, a section of the Safety Data Sheet would increase safety for users facing interaction of the chemical used with electric power equipment; accessible information could include freezing point, melting points, and explosive limits of a chemical, depending on the climate and weather conditions.

According to another aspect of the invention, a user can obtain and access safety or use information from the machine-readable code on a container or, alternatively, a clear or opaque label affixed to a container. The container would have an aperture, allowing the user to urge and dispense the housed chemical from the container. The aperture could be multiple sizes, including up to the diameter, height, or width of the top, side, or base of the container. In addition, the aperture could be located on the top, base, a side, sides of the container, or any other location on the container used by a skilled artisan for urging a chemical from the container for dispensing.

According to another aspect of the invention, this method would allow for the safety or use information of the chemical housed in the container to be readily available even after a user cannot readily view or directly control the container, such as when the container has been employed or disposed of. For example, such employment would occur once a user placed the container, with a housed chemical, in an extendable dispensing device that is out of the immediate reach of the user. An example would include when a user lifts the dispensing device to reach an overhead area of the electric power equipment.

According to another aspect of the invention, a method that provides a user with the most current safety information-such as a Safety Data Sheet or a portion thereof-is imperative for users employing a chemical. For instance, safety information printed on a label at the time of manufacture or distribution may be obsolete by the time it reaches users; in addition, if a chemical container has been stored for several weeks, months, or years, then the safety information reflected on the container or its label could also be outdated; therefore, it is important for users working with chemicals to possess a method to access regulatory-required updates.

According to yet another aspect of the invention, a method for a user to obtain current safety information on a chemical with a Safety Data Sheet when the chemical is housed in a container used for dispensing. Chemicals include main states (i.e., solids, liquids, or gases) or combinations thereof. The container housing the chemical is used for urging the chemical outside the container. Containers could be circular, cylindrical, or rectangular metal housings; aerosol cans; squeeze bottles; or any other container envisioned by the skilled artisan. Propellants used in containers could include, but not be limited to, nitrogen or any other propellant envisioned by the skilled artisan. In addition, urging includes, but is not limited to, expressing, expelling, exhausting, or any other techniques envisioned by the skilled artisan to move the chemical from the container. After urging the chemical outside the container, the user dispenses the chemical from the container. Dispensing includes, but is not limited to, pouring, pumping, propelling, or any other techniques envisioned by the skilled artisan.

According to another aspect of the invention, the method for obtaining current safety information on a chemical having a Safety Data Sheet provides a machine-code reading mobile device. This device would have a display and be capable of interfacing with the worldwide web. Examples of a machine-code reading mobile device could include smart phones, smart devices, or any other device that a skilled artisan would use to read machine-readable codes.

According to another aspect of the invention, the method provides a user with a container having machine-readable code. This machine-readable code could be directly on the container or on a label affixed to the container. In addition, this machine-readable code could be painted, printed, impressed, or placed on the container using any technique used by the skilled artisan.

According to another aspect of the invention, the method provides a website on the worldwide web comprising the current Safety Data Sheet of the chemical housed within the container. The method also allows a user to direct the machine-code reading mobile device, capable of wirelessly connecting to the worldwide web, at the machine-readable code on the container, such that the machine-readable code urges the machine-code reading mobile device to interface with the website on the worldwide web. This website, having the current Safety Data Sheet, would be displayed on the machine-code reading mobile device display. This interface could include wirelessly connecting to the worldwide web (colloquially known as the Internet).

According to yet another aspect of the invention, having manufacturer-generated or distributor-generated use information, especially on the housed chemical within a container, from a website on the worldwide web would also empower users by providing relevant instruction on proper use of an employed chemical. In addition, this website would convey this information to the user in the form of webpages, audio, video, or any other medium used by the skilled artisan to convey information using a machine-code readable device capable of wirelessly connecting to the worldwide web. Using the machine-readable code to transfer and display this information and instructions would help provide users with continuous and near instantaneous access to the best practices set forth by the manufacturer.

### BRIEF DESCRIPTION OF THE SEVERAL VIEWS OF THE DRAWINGS

For a fuller understanding of the nature and advantages of the present method and process, reference should be had to the following detailed description taken in connection with the accompanying drawings, in which:

FIG. 1 shows a schematic block diagram of a system.

The drawings will be described in greater detail below.

### DETAILED DESCRIPTION OF THE INVENTION

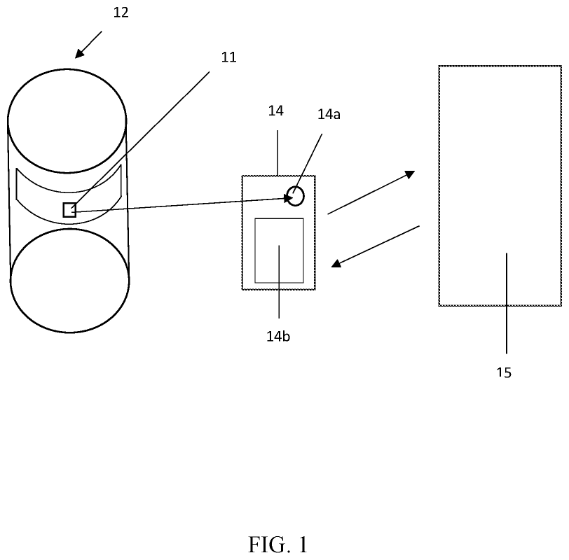

FIG. 1 shows a schematic block diagram of a system. The system includes a machine-code reading mobile device 14, capable of wirelessly interfacing with the worldwide web, having a machine-code recognition element 14a and a display 14b. The system also includes a machine-readable code 11 and a website 15 on the worldwide web that comprises a current Safety Data Sheet on a chemical housed in a container 12 with the machine-readable code 11.

The machine-code reading mobile device 14, capable of wirelessly interfacing with the worldwide web, can access the website 15 on the worldwide web, and the machine-code reading mobile device 14 utilizes its machine-code recognition element 14a to read the machine-readable code 11 on the container 12. Following the machine-readable code 11, the machine-code readable mobile device 14 accesses the website 15 on the worldwide web comprising a current Safety Data Sheet for the chemical housed within the container 12. In addition, the website 15 or portions thereof are displayed on the display 14b of the machine-code reading mobile device 14.

While the apparatus, system, and method have been described with reference to various embodiments, those skilled in the art will understand that various changes may be made and equivalents may be substituted for elements thereof without departing from the scope and essence of the disclosure. In addition, many modifications may be made to adapt a particular situation or material in accordance with the teachings of the disclosure without departing from the essential scope thereof. Therefore, it is intended that the disclosure not be limited to the particular embodiments disclosed, but that the disclosure will include all embodiments falling within the scope of the appended claims. In this application, all units are in the metric system and all amounts and percentages are by weight, unless otherwise expressly indicated. Also, all citations referred herein are expressly incorporated herein by reference.

Various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination. In certain circumstances, multitasking and parallel processing may be advantageous. Moreover, the separation of various system components in the embodiments described herein should not be understood as requiring such separation in all embodiments.

1. A method for a user to obtain current safety information on a chemical having a Safety Data Sheet, the chemical being housed in a container with an aperture used for urging the chemical to be dispensed from the container, the method comprising:
providing a machine-code reading mobile device comprising a display and a machine-code recognition element, wherein the machine-code reading mobile device is capable of interfacing with the worldwide web,
providing a machine-readable code on the container,
providing a website on the worldwide web comprising the current Safety Data Sheet of the chemical housed within the container, the Safety Data Sheet including a plurality of types of safety information,
scanning a bar code to access at least one of the plurality of types of safety information, and
directing the machine-code reading mobile device at the machine-readable code on the container, the machine-code reading mobile device reading the machine-readable code on the container, the machine-readable code urging the machine-code reading mobile device to interface with the website on the worldwide web having the current Safety Data Sheet on the website to be displayed on the machine-code reading mobile device display.

2. The method, as in claim 1, wherein the machine-readable code is a picket-fence bar code.

3. The method, as in claim 1, wherein the machine-readable code is a Quick Response code.

4. The method, as in claim 1, wherein a label displaying the machine-readable code is affixed to the container.

5. The method, as in claim 1, wherein the machine-readable code is printed on the container.

6. The method, as in claim 1, wherein the machine-readable code is painted on the container.

7. The method, as in claim 1, wherein the website on the worldwide web further comprises user information on the chemical housed within the container.

8. The method, as in claim 1, wherein the machine-code reading mobile device is a smart device.

9. (canceled)

10. A method for a user to obtain current safety information on a chemical having a Safety Data Sheet, the chemical being housed in an aerosol can with an aperture used for urging the chemical to be dispensed from the aerosol can, the method comprising:
providing a Quick Response code reading mobile device comprising a display and a Quick Response code recognition element, wherein the Quick Response code reading mobile device is capable of interfacing with the worldwide web,
providing the Quick Response code on the aerosol can,
providing a website on the worldwide web comprising the current Safety Data Sheet of the chemical housed within the aerosol can, the Safety Data Sheet including a plurality of types of safety information,
scanning a bar code to access at least one of the plurality of types of safety information,
directing the Quick Response code reading mobile device at the Quick Response code on the aerosol can, the QR code reading mobile device reading the Quick Response code on the aerosol can, the Quick Response code urging the Quick Response code reading mobile device to interface with the website on the worldwide web having the current Safety Data Sheet on the website to be displayed on the Quick Response code reading mobile device display, and
wherein the plurality of types of safety information include identification, hazard identification, composition/information on ingredients, first-aid measures, fire-fighting measures, accidental release measures, handling and storage, exposure controls/personal protection, physical and chemical properties, stability and reactivity, and toxicological information.

11. The method, as in claim 10, wherein a label displaying the Quick Response code is affixed to the aerosol can.

12. The method, as in claim 10, wherein the Quick Response code is printed on the aerosol can.

13. The method, as in claim 10, wherein the Quick Response code is painted on the aerosol can.

14. The method, as in claim 10, wherein the website on the worldwide web further comprises user information on the chemical housed within the aerosol can.

15. The method, as in claim 10, wherein the Quick Response code reading mobile device is a smart device.

16. The method, as in claim 10, wherein the Quick Response code reading mobile device is a smart phone.

17. A method for a user to obtain current safety information on a non-flammable chemical, having a Safety Data Sheet, with a dielectric strength greater than or equal to thirty-five kilovolts, the chemical and a propellant being housed in an aerosol can with an aperture used for urging the chemical to be dispensed from the aerosol can, the method comprising:
providing a Quick Response code reading mobile device comprising a display and a Quick Response code recognition element, wherein the Quick Response code reading mobile device is capable of interfacing with the worldwide web,
providing the Quick Response code on the aerosol can,
providing a website on the worldwide web comprising the current Safety Data Sheet of the chemical housed within the aerosol can, the Safety Data Sheet including a plurality of types of safety information,
scanning a bar code to access at least one of the plurality of types of safety information,
directing the Quick Response code reading mobile device at the Quick Response code on the aerosol can, the Quick Response code reading mobile device reading the Quick Response code on the aerosol can, the Quick Response code urging the Quick Response code reading mobile device to interface with the website on the worldwide web having the current Safety Data Sheet on the website to be displayed on the Quick Response code reading mobile device display, and
wherein the plurality of types of safety information include identification, hazard identification, composition/information on ingredients, first-aid measures, fire-fighting measures, accidental release measures, handling and storage, exposure controls/personal protection, physical and chemical properties, stability and reactivity, and toxicological information.

18. The method, as in claim 17, wherein a label displaying the Quick Response code is affixed to the aerosol can.

19. The method, as in claim 17, wherein the Quick Response code is printed on the aerosol can.

20. The method, as in claim 17, wherein the Quick Response code reading mobile device is a smart device.

21. The method, as in claim 1, wherein the plurality of types of safety information include identification, hazard identification, composition/information on ingredients, first-aid measures, fire-fighting measures, accidental release measures, handling and storage, exposure controls/personal protection, physical and chemical properties, stability and reactivity, and toxicological information.
